(19) United States
(12) Patent Application Publication
(10) Pub. No.: US 2002/0032726 A1
(43) Pub. Date: Mar. 14, 2002

(54) Method and device for processing an electronic document in a communication network

(76) Inventors: Jean-Jacques Moreau, Rennes (FR); Herve Dias, Saint Malo (FR); Francois Delumeau, Paris (FR)

Correspondence Address: FITZPATRICK CELLA HARPER & SCINTO, 30 ROCKEFELLER PLAZA, NEW YORK, NY, 10112, US

(21) Appl. No.: 09/923,415

(22) Filed: Aug. 8, 2001

(30) Foreign Application Priority Data
Sep. 14, 2000 (FR) 0011729

(51) Int. Cl. G06F 15/16

(52) U.S. Cl. 709/203

(57) ABSTRACT

A method for the transmission of the pages of an electronic document (100) by a client station to a server station connected by a communication network, with a view to the processing of the document by a processing peripheral, includes the steps of sending (S403) to the server station a document processing request; receiving (S405) a page request from the server station, the page request including information identifying a page of the document; translating (S407) orders corresponding to the page identified in the page request into a computer communication language; sending (S409) to the server station a response containing the translated orders corresponding to the identified page. Correlatively, a method of processing an electronic document in the server station includes the steps of a receiving a message from the client station, the message including information identifying a page to be processed of the document; sending a page request to the client station, said page request including the said page identification information, and aimed at obtaining from the client station the processing orders corresponding to the page identified by the identification information; receiving a response from the client station, the response containing the orders corresponding to the identified page translated into the computer communication language.

The present invention relates to the field of the processing of electronic documents in communication networks.

The invention concerns a method for processing an electronic document. The invention concerns more particularly a method of transmitting pages of an electronic document by means of a client station to a server station connected by a communication network, with a view to the processing of a document by a processing peripheral; and a method of processing an electronic document in a server station connected, via a communication network, to at least one client station, the server station being responsible for the management of at least one electronic document processing peripheral.

The invention also concerns devices able to implement the aforementioned methods.

In a communication network, several client stations, generally microcomputers, can be connected via the network to electronic document processing peripherals. The term “peripherals” encompasses, non-exhaustively, printers, scanners and facsimile machines. These peripherals are often accessible via a server, typically a computer connected to the network, responsible for managing one or more peripherals, often of the same type. It may be a case for example of a printing server.

Conventionally, the use of a peripheral by a client station requires the prior installation of a driver for this peripheral in the client station. This driver, consisting of a software component, is specific to the type and model of peripheral used, and to the operating system of the client computer.

Moreover, these peripherals generally have parameterisable operating modes whose parameters can be fixed by the user, at the end of a dialogue between him and a software application running on the client station and from which the processing of a document in question can be controlled. This is then referred to as configuration of the processing peripheral.

For example, in the case of a printer, the configuration thereof notably takes account of the parameters concerning the type of ink or paper used, the required resolution or the print speed.

Consequently, if it is wished to take best advantage of a peripheral, it is necessary to set a large number of parameters and, for each of them, to fix a suitable value amongst all those offered by the peripheral.

Thus, in general terms, it is necessary to install, on a given client computer, as many device drivers as there are different peripherals which the user wishes to be able to use via the network. This entails the client computer having sufficient memory resources. Moreover, the installation and configuration of a peripheral are operations which are not easy and are sometimes even outside the capability of an average user, that is to say someone who is not a computer specialist.

Moreover, with regard to the printing of electronic documents such as photographs, it is now possible to print documents from appliances having very limited data processing resources (memory, processor). Such is the case for example with certain digital photographic appliances generating electronic documents defined by a set of pixels. These appliances can now be connected to a communication network. However, since they do not have sufficient data processing resources to be able to incorporate one or more printer drivers, they cannot use printers accessible via the network.

The present invention aims to remedy the aforementioned drawbacks.

In particular, the purpose of the invention is to simplify, from the point of view of the user, the use of a document processing peripheral; and to minimise the data processing resources necessary, in a client station, to be able to control, from this station, the processing of an electronic document via a communication network.

To this end, the present invention concerns, according to a first aspect, a method for the transmission of the pages of an electronic document by a client station to a server station, connected by a communication network, with a view to the processing of the document by a processing peripheral. The method includes the prior steps of generating orders corresponding to the pages of the electronic document to be processed, storing the said orders grouped by page of the document, and sending a message requesting processing of the document to the server station. The method is characterised in that it includes the following steps:

(A) receiving a request message, referred to as a “page request”, sent by the server station, the said page request including information identifying a page of the document;

(B) translating into a computer communication language orders corresponding to the page identified in the page request;

(C) sending to the server station a response message containing the translated orders corresponding to the identified page.

By translating the orders corresponding to a given page of the document into a computer communication language, it is not necessary for a driver of the peripheral chosen for the processing to be installed in the client station. The transmission method is consequently independent of the characteristics of the processing peripheral selected. Moreover, the user no longer has to configure the peripheral, the configuration task being transferred at the level of the server station.

In addition, by transferring the configuration and driver functions of the processing peripheral, at the server station, the memory resources and the processing capacities required in the client station are minimised. Consequently it can be envisaged implementing the invention (the client part) in appliances having limited data processing resources such as a digital photographic apparatus. In particular, in the field of the Internet, the invention can be applied to Internet terminals, portable telephones or electronic diaries.

In practice, steps (A), (B) and (C) are recommenced until all the pages of the document have been sent.

According to a particular characteristic of the invention, the document processing request message includes an electronic address indicative of the storage location of the orders corresponding to the first page of the document to be processed.

According to a preferred embodiment of the invention, the transmission method includes, before the step of sending the said processing request message, a step of associating, with each of the pages of the document, an electronic address indicative of the storage location of the orders corresponding to the page in question. The response message, containing the translated orders of a page, also includes the storage electronic address of the orders corresponding to the following page to be processed of the document. The information identifying a page of the document, contained in the requested page received from the server station, is then the storage electronic address of the orders corresponding to a page of the document.

In practice, the processing request message includes information identifying a processing peripheral.

According to a second aspect, the invention concerns a method of processing an electronic document in a server station, connected via a communication network to at least one client station, and responsible for the management of at least one electronic document processing peripheral. The method is characterised in that it comprises the following steps:

(D) receiving a message coming from a client station, said message including information identifying a page to be processed of an electronic document;

(E) sending a request message, referred to as a page request, to the client station, said page request including the page identification information, and aimed at obtaining from the client station the processing orders corresponding to the page identified by the identification information;

(F) receiving a response message from the client station, the response message containing the orders corresponding to the identified page translated into a computer communication language.

According to a preferred embodiment, the processing method according to the invention includes a prior step of receiving in the server station a processing request message coming from the client station, the processing request message including information identifying a processing peripheral and information identifying a first page to be processed of the document. The response message received from the client station also includes information identifying a following page to be processed of the document.

In a preferred embodiment of the invention, the processing method also includes the following steps:

(G) converting the orders received, from the computer communication language to a data format appropriate to the processing of the orders by the processing peripheral identified by the peripheral identification information;

(H) processing the orders converted by the identified peripheral.

In practice, steps (E) to (H) are recommenced until all the pages of the document have been processed.

According to a particular characteristic of the invention, the information identifying a page to be processed of the electronic document is an electronic address indicative of the storage location of the orders corresponding to the page in question.

According to a preferred embodiment of the invention, the step (H) of processing the orders includes a step of generating processing codes, from the converted orders, by a processing driver associated with the processing peripheral, and a step of sending codes to the processing peripheral.

Correlatively, the invention also concerns a device for transmitting pages of an electronic document by a client station to a server station connected by a communication network, with a view to processing the document by means of a processing peripheral. The transmission device has means for generating the orders corresponding to the pages of the electronic document to be processed, means for storing the orders grouped together by page of the document, and means for sending a document processing request message to the server station. The device is characterised in that it comprises:

means for receiving a request message, referred to as a “page request”, sent by the server station, said page request including information identifying a page of the document;

means for translating into a computer communication language the orders corresponding to the identified page in the page request;

means for sending to the server station a response message containing the translated orders corresponding to the identified page.

According to a preferred embodiment of the invention, the transmission device has association means for associating with each of the pages of the document an electronic address indicative of the storage location of the orders corresponding to the page in question.

According to a particular design characteristic, the association means include an association table containing, for each page of the document, an electronic address indicative of the storage location of the orders corresponding to the page in question; and means of updating the association table according to the document to be processed and the pages of the document already processed.

Likewise, the invention also concerns a device for processing an electronic document in a server station, connected via a communication network to at least one client station, and responsible for the management of at least one electronic document processing peripheral. The processing device is characterised in that it comprises:

means for receiving a message coming from a client station, the message including information identifying a page to be processed of an electronic document;

means for sending a request message, referred to as a “page request”, to the client station, said page request including said page identification information, and aimed at obtaining from the client station the processing orders corresponding to the page identified by the identification information;

means for receiving a response message from the client station, said response message containing the orders corresponding to the identified page translated into a computer communication language.

According to a preferred characteristic of the invention, the processing device also has means for first receiving a processing request message coming from the client station, the processing request message including information identifying a processing peripheral and information identifying a first page to be processed of the document. The response message received from the client station also includes information identifying a following page to be processed of the document.

According to another preferred characteristic of the invention, the processing device also comprises means for converting the orders received, from the computer communication language into a data format appropriate to the processing of the orders by the computer peripheral identified by the peripheral identification information; and processing means for allowing the processing, by the identified peripheral, of the orders converted into said data format.

The invention also relates to a client station connected to a communication network, characterised in that it comprises a device for transmitting pages of an electronic document as defined above.

The invention also relates to a server station connected to a communication network, characterised in that it comprises an electronic document processing device as defined above.

The invention also relates to a communication network having at least one client station in accordance with the invention, and at least one server station in accordance with the invention.

The invention also relates to a computer system having means adapted to implement at least one of the methods according to the invention as disclosed above.

The invention also relates to a computer program containing one or more sequences of program instructions able to implement at least one of the methods according to the invention as disclosed above, when this program is executed by a computer.

The invention also relates to an information carrier, such as a diskette or a compact disc (CD), characterised in that it contains such a computer program.

The advantages of these devices, stations, computer system, computer program and information carrier are identical to those of the methods as succinctly disclosed above.

Other particularities and advantages of the invention will also emerge from the following description. In the accompanying drawings, given by way of non-limitative examples:

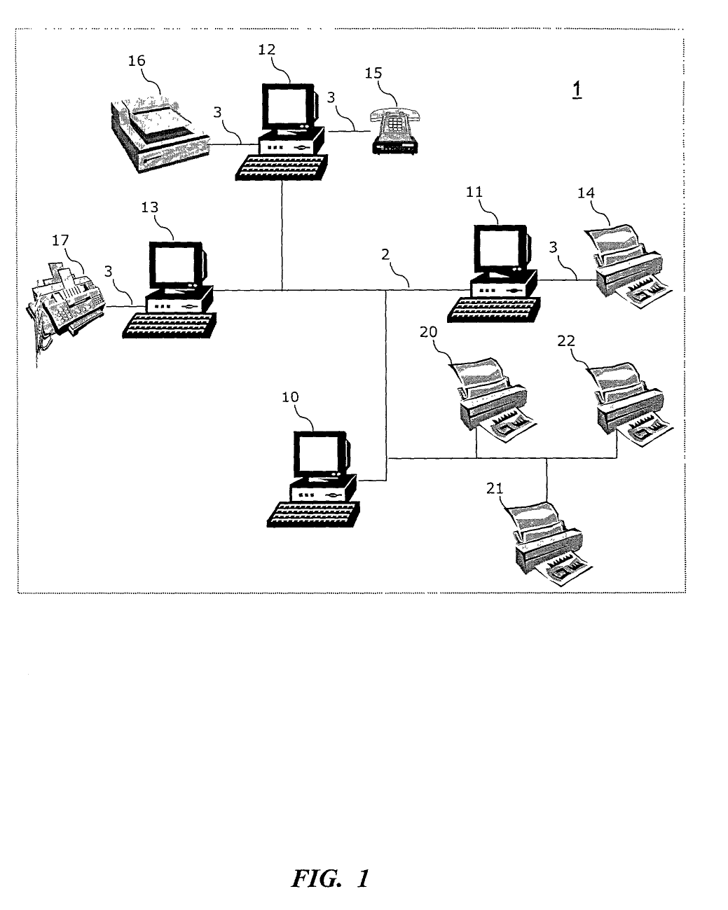

FIG. 1 depicts a communication network in which several client stations are in relationship with a server station dedicated to the management of electronic document processing peripherals;

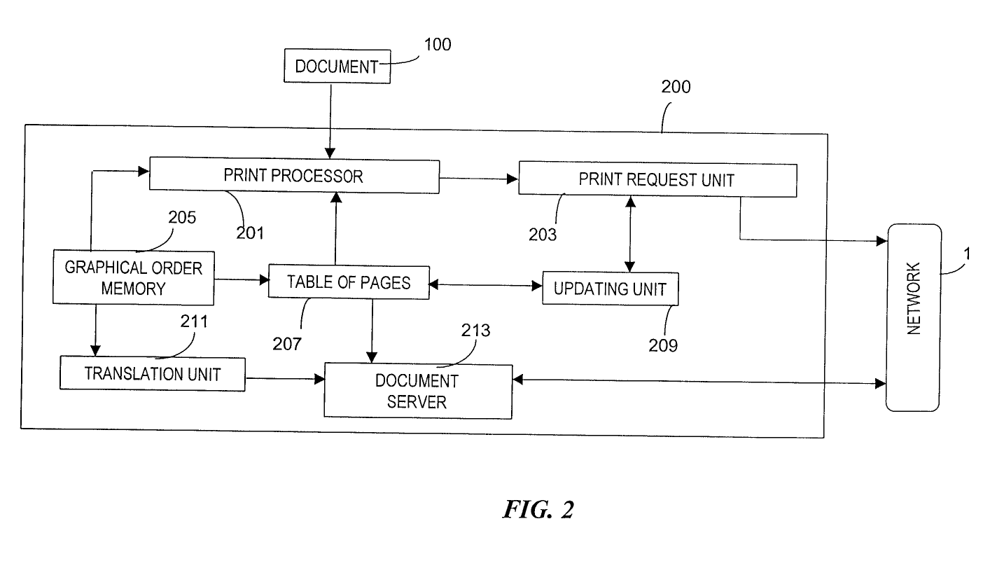

FIG. 2 is a functional diagram illustrating the elements of a document processing device according to the invention which are incorporated in a client station;

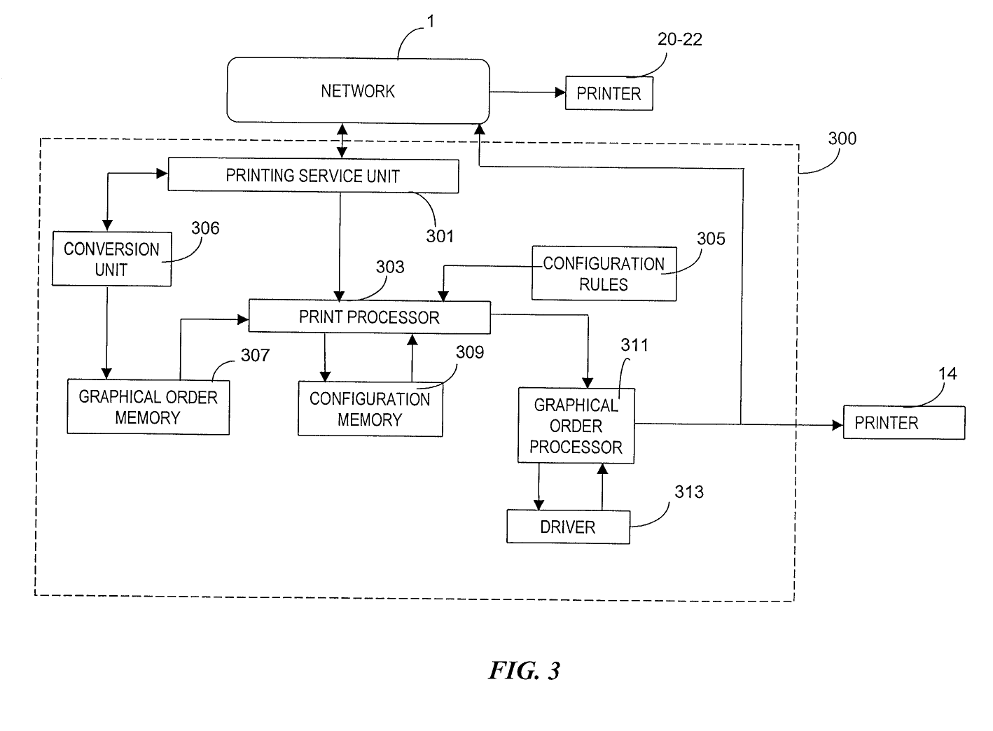

FIG. 3 is a functional diagram illustrating the elements of a document processing device according to the invention which are incorporated in a server station;

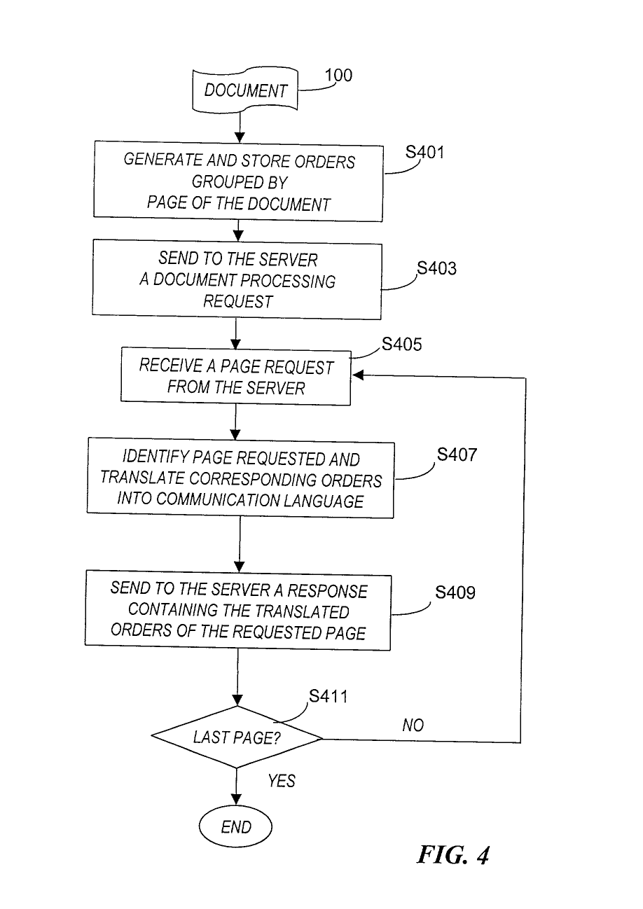

FIG. 4 is a flow diagram illustrating the principle on which a method is based of transmitting pages of a document from a client station to a server station (document processing method, client part), in accordance with the invention;

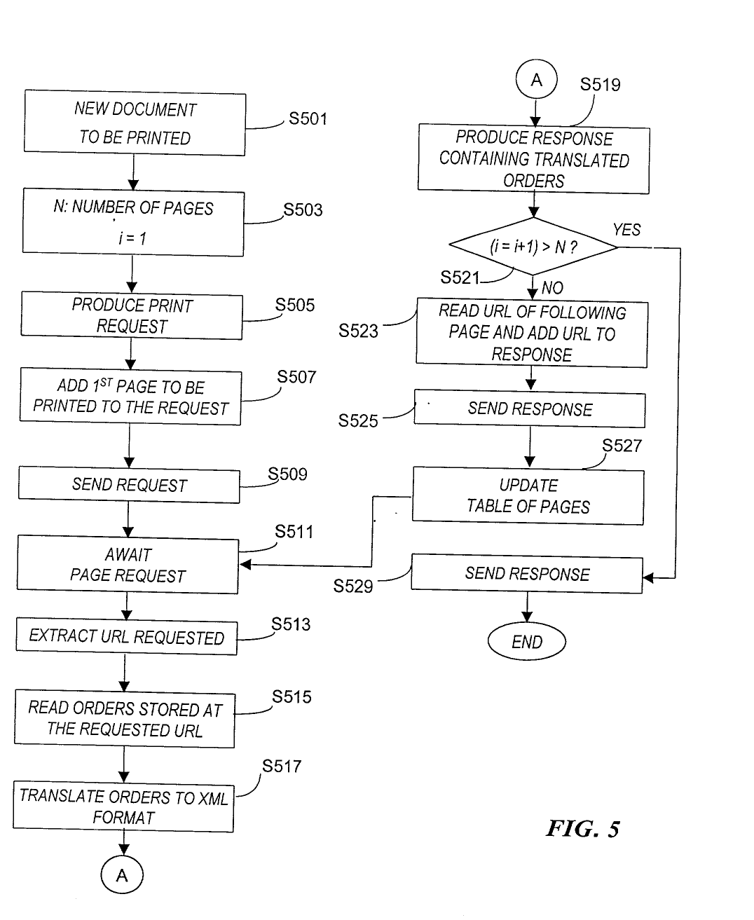

FIG. 5 is a flow diagram detailing the steps of the document processing method according to the invention which are implemented in a client station;

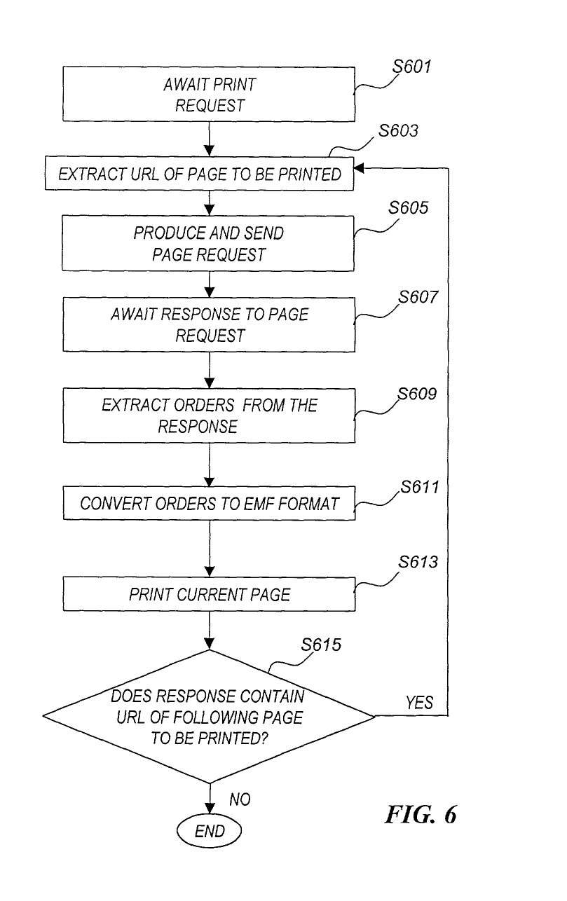

FIG. 6 is a flow diagram illustrating the steps of the document processing method according to the invention which are implemented in a server station;

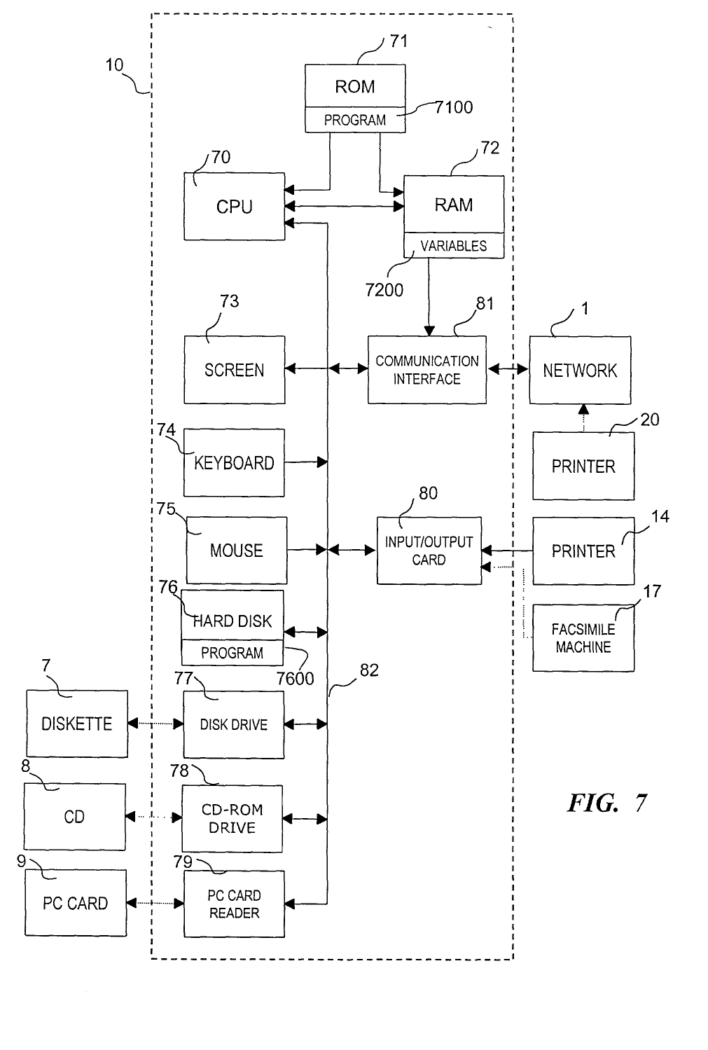

FIG. 7 depicts schematically a computer adapted to implement a document processing method in accordance with the invention.

With reference to FIG. 1, a description will be given of an example of a communication network adapted to implement the invention.

The network 1 represents any type of network, for example a local area network (LAN) based on a known architecture such as Ethernet or Token Ring, or a metropolitan area network (MAN), for example a company network, or a wide area network (WAN) such as a world network like the Internet.

In the preferred embodiment described here, the network in question is the Internet.

The network 1 has a plurality of stations such as computers, and a plurality of peripherals, the peripherals being connected to the stations either by direct links 3, or through the network, by means of a set of links and nodes 2.

As illustrated in FIG. 1, the network 1 has four stations 10-13, for example microcomputers or workstations.

The network 1 uses the principle known as “client-server” for the exchange of information or services between the stations. According to this principle, applied by way of example to the transfer of documents, a so-called “client” station sends a request to process an electronic document to a so-called “server” station responsible for managing several processing peripherals.

The client stations can be user systems, whilst the server stations can be network servers dedicated to supplying documents or services such as for example the printing of documents. However, each of the network stations in question can also, according to the direction of the transaction carried out, be “client” or “server”.

Thus, in the network 1, the stations 10, 12, 13 are client stations vis-à-vis the station 11, which serves as a server for printing electronic documents. In this regard, the server station 11 manages the access to and use of three printers 20, 21, 22 connected to the network, and a printer 14 directly connected to the server station.

It should be noted here that “electronic document” means a set of data which can be of very varied natures: text file, image, video, sound, etc.

Processing peripherals of different types can be connected to these stations to implement different types of document processing. For example, a modem 15 and a scanner 16 are connected to the station 12, and a facsimile machine 17 is connected to the station 13.

These processing peripherals 14, 15, 16, 17 are connected to the corresponding stations by dedicated connections (3) of suitable types which are normal in computer networks, such as, for example, serial, parallel or SCSI (Small Computer Simple Interface) connections.

In the context of the embodiment of the invention described and depicted here, the electronic document processing peripherals in question are printers (20, 22, 21); however, the invention also applies to other types of peripherals such as scanners or facsimile machines.

In the network depicted in FIG. 1, the client stations 10, 12, 13 can use at a distance the electronic document printing service dispensed by the server station 11. The printing server 11 thus offers the possibility to the client stations of using any one of the printers 20, 21, 22 and 14.

FIG. 2 is a functional diagram depicting the elements of a document configuration device according to the invention, which are incorporated in a client station (11, 12 or 13) connected to the network 10. These elements constitute the “client part” or “client device” of the peripheral configuration device according to the invention.

The client device 200 as illustrated in FIG. 2 makes it possible to transmit the pages of an electronic document (100) by means of the client station in question, via the network 1, to the server station 11, in order to have the document processed by one of the peripherals (20-22, 14).

As mentioned above, in the context of the embodiment described here, the peripherals in question are, non-limitatively, printers (20-22, 14).

The client device 200 conventionally comprises a print manager 201 making it possible to generate orders from an electronic document (100) selected by a user of the client station in order to be printed. The print manager is sometimes referred to as a “Print Processor” (for example in the operating system known as Windows® from the Microsoft Corporation).

The orders managed by the print manager 201 are generally graphical orders, for example of the type “draw a line”, “draw an ellipse”, “draw a representation in bitmap mode”.

The client device 200 also has a graphical order memory 205 for storing the orders supplied by the print manager 201, grouping them together by pages of the document.

In practice, the orders corresponding to each page of the document to be printed are stored in a computer file.

For example, in an embodiment in which use is made of a data processing system managed under the Windows® operating system, the graphical orders sent by an application are received by a graphical orders manager (referred to as GDI, graphic device interface, in Windows®) and stored in EMF files (Enhanced MetaFiles), each file corresponding to a document page.

The client device 200 also has means for sending a document print request message to the server station. These means are incorporated in a print request unit 203.

The processing request message contains information identifying a printer chosen by the user or defined by default by the application in charge of the document. In practice, this printer identification information is a network address identifying a printer on the network, for example an IP (Internet Protocol) address.

In accordance with the invention, the client device 200 has means for receiving, via the network 1, a request message, designated here as “page request”, sent by the server station 11. These means of receiving page requests are incorporated in a unit called a “document server” 213. A page request sent by the server station includes information identifying a page of the electronic document to be printed.

In accordance with the invention, the client device 200 also has a translation unit 211 intended to translate, into a given computer communication language, the orders corresponding to a page identified in a page request.

In the preferred embodiment of the invention in which the network 1 is a network of the Internet type, that is to say using the protocols and resources developed for the Internet, this communication language is a language of the “hypertext markup language” type.

In practice, the language used is the language known by the acronym “XML” (extended Markup Language).

In this embodiment, the client stations (10, 12, 13) and the server station (11) communicate using the HTTP protocol (HyperText Transfer Protocol), that is to say a protocol of the “hypertext transfer protocol” type.

In accordance with the invention, the client device 200 also has means for sending to the server station 11 a response message, in response to a page request, containing the orders translated from the requested page into the computer communication language. These means of sending a response message are incorporated in the document server 213.

In accordance with the invention, the client device 200 also association means intended to associate, with each of the pages of the document, an electronic address indicative of the storage location of the orders corresponding to the page in question.

These association means comprise an association table designated as a “table of pages” 207, and an update unit 209 intended to update the association table according to the document to be printed and the pages of the document which have already been printed.

The update unit 209 cooperates with the graphical order storage unit 205 in order to associate, in the table of pages 207, with each of the pages 5 of the document, an electronic address indicative of the storage location of the orders corresponding to the page in question. A given page of the document can for example be identified in the association table 207 by a number corresponding to its rank for printing.

Thus, in accordance with the invention, using the table of pages 207, the print request unit 203 is adapted to incorporate in the print request the electronic address indicative of the storage location of the orders corresponding to the first page of the document to be printed.

In addition, the response message, generated by the document server 213 in response to a page request received from the server station, contains, in addition to the translated orders from the page requested by the server, the electronic address for storing the orders corresponding to the following page to be processed of the document. The following page to be processed of the document is determined in the association table as being the one whose electronic address for storing the orders immediately follows the address of the page requested by the server in its page request.

In addition, the information containing a page of the document, contained in the page request received from the server station, is the electronic address for storing the orders corresponding to a page of the document.

In the preferred embodiment of the invention in which the network 1 is the Internet, the electronic address at which there are stored the orders corresponding to a page of the document to be printed is an address of the type known by the acronym “URL” (Uniform Resource Locator).

In the embodiment in which the communication protocol used between the client station and the server station is the HTTP protocol, the aforementioned messages (processing request, response containing the translated orders, and page request) are HTTP messages including an additional field containing the URL corresponding to a page to be processed of the document. This additional field is designated in this embodiment as “Xnext”.

A description will now be given, with reference to FIG. 3, of the elements of the document processing device according to the invention which are incorporated in the server station 11 connected to the network 1.

FIG. 3 is a functional diagram depicting these elements, which constitute the “server part” or “server device” of the document processing device according to the invention.

The server device 300 as illustrated in FIG. 3 makes it possible to effect the actual processing (for example printing) of a document whose pages are transmitted to it by the client device 200 as described above in relation to FIG. 2.

The server device 300, incorporated in the server station 11, has a unit 301 known as a “print service unit” connected to the network 1.

In accordance with the invention, the unit 301 has means for receiving a message coming from a client station (10, 12, 13), the said message containing information identifying a page to be processed in an electronic document.

As disclosed previously in relation to FIG. 2, in practice this identification information is the electronic address (URL) corresponding to the storage location of the orders corresponding to a page of the document.

Such a message received from the client station is either a print request message, or a message in response to a page request from the server station. When the message is a print request, the electronic address contained in the message is the one corresponding to the first page to be printed of the document. A print request also contains information identifying a printer, such as a network address (for example IP address).

When the message is a response message, the electronic address contained is the one relating to the following page to be printed of the document.

The unit 301 consequently has means for sending a request message, here referred to as a “page request”, to the client station, in response to the aforementioned message received from the client station. The page request then contains the electronic address extracted from the message received from the client station. The page request thus aims to obtain from the client station the processing orders corresponding to the page identified by the electronic address.

The print service unit 301 also has means for receiving a response message from the client station as described above in relation to FIG. 2. This response message contains the orders, corresponding to the identified page, translated in the client station into a computer communication language (XML) prior to the sending of the response message.

The server device 300 has a conversion unit 306. When a response message containing graphical orders in the XML format is received, the unit 301 transmits the orders received to the conversion unit 306 so that the latter converts them from the computer communication language (XML) into a format appropriate to their processing by the identified printer. This appropriate format is for example the EMF format when the server station uses the Windows® operating system.

The server device 300 also has a graphical order memory 307. Once converted into an appropriate format by the conversion unit 306, the orders are temporarily stored in the graphical order memory 307.

When the orders received have been converted and stored, the print service unit 301 informs a print manager 303 that a new print work should be executed.

Conventionally, the print manager 303 then recovers the graphical orders stored in the memory 307 and sends them in blocks to processing means intended to permit the processing of orders converted (EMF format) by the printer.

These processing means include, in a conventional manner, a graphical order manager 311 associated with a printer driver 313. The printer driver is conventionally a software module dedicated to communication with the printer in question, which has its own operating software for performing a set of elementary operations.

The driver makes a translation of a set of orders sent by the graphical order manager 311 into a set of printing orders, referred to as print codes, which can be read by the printer in question.

The print codes are then returned to the graphical order manager 311 by the printer driver 313, in order then to be sent to the printer, which can thus effect the printing proper of a page of the document. The printer can be either a local printer, that is to say one directly connected to the server station, such as the printer 14, or a remote printer (20, 21, 22) managed by the server station through the network (1).

The operation of translating the orders into print codes requires the prior configuration of the printer, that is to say of the driver.

The configuration amounts to fixing the value of each parameter of this translation. These parameters concern for example the translation of the character font of a text into a series of dots able to be formed by the printer, or of the colour palette of a document into a colour palette of the printer. These parameters also concern the colour or black and white print mode, the print quality, etc.

The configuration of the printer in question is effected, in a conventional manner, by means of a unit 305 for storing the configuration rules, and a configuration memory 309. In practical terms, the unit 305 contains, in storage, a set of pre-recorded configurations for the printer in question. The configuration memory 309 for its part stores the chosen (current) configuration for printing the document.

As mentioned above, a set of fixed values of the configuration parameters constitutes a particular configuration of the printer. Thus the process normally referred to as the “printer configuration” is in reality a process of configuring the printer driver of the printer. In accordance with the invention, the configuration process is effected in the server station and not in the client station.

In parallel to the printing of a page of the document by the printer, the printing server 301 sends a page request to the client station in order to request the orders corresponding to the following page to be printed of the document.

A description will now be given, in relation to FIG. 4, of the principle on which a method according to the invention of transmitting the pages of a document from a client station to a server station is based. It is a case in reality of the “client part” of the document processing method according to the invention.

With reference to FIG. 4, a document 100 was selected by a user connected to a client station (10, 12, 13), in order to be printed by a printer accessible via the server station 11.

In a first step (S401), in the client device 200 of the client station in question, the graphical orders corresponding to the selected document are generated and are stored by grouping them together by page of the document.

In a second step (S403), the client device 200 sends a print request to the server station.

In response to this print request, at step S405, the client device receives a page request from the server station. The page request contains identification information for a page of the document.

At the following step (S407), a page of the document, the subject of the page request, is identified in the client device, and then the orders corresponding to this page are translated into a communication language (XML).

At the following step (S409), a response to the page request is sent to the server, the said response containing the orders, translated into the communication language, for the page requested.

The following step (S411) is a test step in which it is determined whether the current page (the requested page) is the last page to be printed of the document. In the affirmative, the page transmission process is terminated.

In the negative, step S405 is returned to and there is a wait until another page request sent by the server station is received. Then steps S407, S409, S411, S405 are recommenced until all the pages of the document have been sent.

In relation to FIGS. 5 and 6, a description will now be given in more detail of the steps of the method of processing a document according to the invention which are implemented in the client station and in the server station.

FIG. 5 details the steps of the method of processing a document which implemented in the client station (the “client part”), whilst FIG. 6 details the steps of the processing method which are implemented in the server station (the “server part”).

As mentioned above in relation to FIG. 4, the “client part” of the method of processing a document according to the invention can be defined as a method of transmitting the pages of an electronic document by means of a client station to a server station, with a view to the processing of the document by a processing peripheral.

The “server part” of the method can be defined correlatively as a method of processing an electronic document in a server station, connected via a communication network to at least one client station.

In the embodiment described, the processing of the document consists of a printing.

In FIG. 5, in a first step (S501), a user connected to a client station selects a document intended to be printed, for example from an electronic document processing application such as word processor software.

The graphical orders corresponding to the pages of the document to be printed are then generated by the print manager 201 and stored by page of the document (EMF files) in the graphical orders memory 205. An association table (“tables of pages”) 207 is then created.

The following step (S503) is an initialisation step in which variables (i: counter; N: number of pages of the document) are initialised.

At the following step (S505) the print request unit 203 of the client device 200 of the client station produces a print request. The print request contains the network address of the printer chosen for the printing.

At step S507, the URL corresponding to the orders (storage location of the orders) of the first page to be printed of the document is read in the table of pages 207 and is incorporated, by the print request unit 203, in the print request.

At the following step (S509), the unit 203 sends the print request, via the network 1, to the server station (11). The unit 213 (the document server) then goes into a state of awaiting (step S511) a page request sent in response by the server station.

In FIG. 6, at step S601, the print service unit 301 of the server station which was in a state of awaiting a print request sent by a client station receives the print request. At step S603, the URL contained in the print request is extracted.

At the following step (S605), the print service unit 301 of the server station produces and sends to the client station a page request containing the URL previously extracted from the print request. Then the unit 301 goes into a state of awaiting a response sent by the client station (S607).

Returning to FIG. 5, in the client station, when the document server 213 receives the page request sent by the server station, the URL contained in the page request is extracted (step S513). The graphical orders stored in the graphical order memory (205) at the memory location corresponding to this URL are then read by the translation unit 211 (step S515).

At the following step, S517, the orders read, corresponding to the page requested, are translated by the translation unit 211 into the XML language.

At the following step S519, the document server 213 produces a response message containing the translated orders.

The following step (S521) is a test step in which first of all the variable i (page counter) is incremented in order to take account of the current page, and then the value of i is compared with the total number N of pages in the document.

If the value of the variable i is strictly greater than the number of pages N, this means that the page currently being processed (the current page) is the last page of the document. In this case, step S529 is passed to directly. At this step, the document server 213 of the client station sends to the server station the response message containing the translated orders corresponding to the last page of the document, and the document page transmission process ends there.

If on the other hand the current page is not the last page of the document, step S523 is passed to, in which the document server reads in the table of pages (207) the URL of the following page to be printed, and incorporates this URL in the response message.

The response message, containing the orders translated by the current page and the URL of the following page to be printed, is then sent to the server station (S525).

At the following step (S527), the table of pages 207 is updated by the update unit 209. The updating of the table consists of the elimination of the data corresponding to the current page.

The client device then goes into a state of awaiting a new page request (step S511).

In FIG. 6, the server device, which was in a state of awaiting (S607) a response to the page request sent previously, receives the response message sent by the client station.

At step S609, the print service unit (301) extracts the orders (XML document), corresponding to the current page, contained in the response message (HTTP message), and transmits the extracted orders to the conversion unit 306. At step S611, the conversion unit 306 converts the orders from the XML format to the EMF format. The converted orders are then stored temporarily in the graphical orders memory 307 and the processor printing these orders (the current page) is then triggered (step S613).

In parallel, the print service unit 301 determines (step S615) whether the response message received from the client station contains a URL in addition to the previously extracted orders.

If such is the case—the response message has therefore been sent at step S525 in FIG. 5—this URL corresponds to the following page to be printed of the document, and steps S603 to S615 are then recommenced as described above.

If the response message does not contain any URL—the response message has therefore been sent at step S529 of FIG. 5—this means that the current page is the last page of the document. In this case the process of processing in the server station ends there, and an end of document processing message is if necessary (according to the implementation) sent to the client station.

With reference now to FIG. 7, a description will be given of a computer adapted to incorporate the components constituting the server part and/or the client part of the document processing device, in accordance with the present invention, which was described above, notably in relation to FIGS. 2 and 3.

Indeed, the client device and the server device can be incorporated in the same station, for example when the station, connected to a network, is a client for certain peripherals accessible on the network, or a server for other peripherals.

Naturally, in an equivalent manner this computer comprises, consequently, means able to implement an electronic document processing method (server part and/or client part) according to the invention and described above, notably in relation to FIGS. 4 to 6.

In this embodiment, the means constituting the electronic document processing device according to the invention are essentially software components or programs.

Consequently, these software components contain one or more sequences of instructions whose execution by said computer enables the methods according to the invention to be implemented.

In FIG. 7, the computer 10, which can typically be a microcomputer or a workstation, has in a conventional fashion a central unit (CPU) 70, connected to a read only memory (ROM) 71 and to a random access memory (RAM) 72, as well as to the data bus 82.

The data bus 82 allows communication between the different sub-elements of the computer 10, or the elements which are connected to it. However, communication between the different sub-elements of the computer is not limited to the bus 82. In particular, the central unit 70 is able to communicate instructions to any sub-element of the computer 10 directly or by means of another sub-element of the computer 10.

The computer 10 has a communication interface 81 connected to a communication network 1 such as the Internet. This communication interface 81 comprises for example a modem of a type known to a skilled person. Via the communication interface 81, the computer 10 can allow, for example, the printing of documents on a remote printer 20 accessible over the network.

The computer 10 also has in a conventional manner a data storage means such as, for example, a hard disk 76. It may also have a disk drive 77, a CD-ROM drive 78 and a reader for cards in the so-called PC-CARD format 79.

A diskette 7, a compact disc (CD) 8, a card 9 of the PC-CARD type—intended to be read respectively by the disk drive 77, the CD-ROM drive 78 and the card reader 79—as well as the hard disk 76, can be used for storing electronic documents, as well as for the storage of the software code enabling the document processing method according to the invention to be implemented.

According to a preferred embodiment, the executable code of the program for implementing the document processing method is stored in the hard disk 76 (program 7600).

According to a variant embodiment, the executable code of this program is stored in the ROM 71 (program 7100).

According to another variant embodiment, the executable code of the program can be downloaded from the communication network 1 via the communication interface 81 in order to be stored on the hard disk 76.

The communication interface 81 has for example a program product known as a “Web browser”.

When the program is executed, the variables created and modified are stored in the registers of the RAM 72 (variables 7200).

The computer 10 also has a screen 73 for displaying a graphical interface between the program according to the invention and the user, the latter being able to make requests by means for example of a pointing device such as a mouse 75, or by means of a keyboard 74.

The computer 10 also has various peripherals, such as a printer 14, making it possible, for example, to print downloaded documents, or a facsimile machine 17. These peripherals are connected to the computer via an input/output card 80.

Naturally, many modifications can be made to the embodiments of the invention described above without departing from the scope of the invention.

1. A method for the transmission of the pages of an electronic document (100) by a client station (10, 12, 13) to a server station (11), connected by a communication network (1), with a view to the processing of the document by a processing peripheral (14, 20-22), the method including the prior steps of generating (S401) orders corresponding to the pages of the said electronic document to be processed, storing (S401) the said orders grouped by page of the document, and sending (S403) a message requesting processing of the document to the server station, the method being characterised in that it comprises the following steps:
(A) receiving (S405) a request message, referred to as a “page request”, sent by the server station, the said page request including information identifying a page of the document;
(B) translating (S407) in a computer communication language orders corresponding to the page identified in the page request;
(C) sending (S409) to the server station a response message containing the translated orders corresponding to the identified page.

2. A method according to claim 1, characterised in that steps (A), (B) and (C) are recommenced until all the pages of the document have been sent (S41 1).

3. A method according to claim 1 or 2, characterised in that the said document processing request message includes an electronic address indicative of the storage location of the orders corresponding to the first page of the document to be processed.

4. A method according to claim 3, characterised in that it includes, before the step of sending the said processing request message, a step of associating, with each of the pages of the document, an electronic address indicative of the storage location of the orders corresponding to the page in question; and in that:
said response message, containing the translated orders of a page, also includes the storage electronic address of the orders corresponding to the following page to be processed of the document; and
said information identifying a page of the document, contained in said page request received from the server station, is the storage electronic address of the orders corresponding to a page of the document.

5. A method according to claim 3 or 4, characterised in that said processing request message includes information identifying a processing peripheral.

6. A method according to claim 5, characterised in that said information identifying a peripheral is a network address identifying a peripheral on the network.

7. A method according to any one of the preceding claims, characterised in that the orders corresponding to each page of the document to be processed are stored in a computer file.

8. A method according to claim 7, characterised in that the computer file for storing the orders is a file of the EMF type.

9. A method of processing an electronic document in a server station (11), connected via a communication network (1) to at least one client station (10, 12, 13), and responsible for the management of at least one electronic document processing peripheral (14, 20-22), the method being characterised in that it comprises the following steps:
(D) receiving (S601, S607) a message coming from a client station, said message including information identifying a page to be processed of an electronic document;
(E) sending a request message (S605), referred to as a page request, to the client station, said page request including said page identification information, and aimed at obtaining from the client station the processing orders corresponding to the page identified by the identification information;
(F) receiving (S607) a response message from the client station, said response message containing the orders corresponding to the identified page translated into a computer communication language.

10. A method according to claim 9, characterised in that it includes a prior step of receiving (S601) a processing request message coming from the client station, said processing request message including information identifying a processing peripheral and information identifying a first page to be processed of the document; and in that said response message received (S607) from the client station also includes information identifying a following page to be processed of the document.

11. A method according to claim 10, characterised in that it also includes the following steps:
(G) converting (S61 1) the orders received, from the computer communication language to a data format appropriate to the processing of said orders by the processing peripheral identified by said peripheral identification information;
(H) processing (S613) said orders converted by the identified peripheral.

12. A method according to claim 11, characterised in that steps (E) to (H) are recommenced until all the pages of the document have been processed.

13. A method according to claim 12, characterised in that said information identifying a page to be processed of the electronic document is an electronic address indicative of the storage location of the orders corresponding to the page in question.

14. A method according to any one of claims 11 to 13, characterised in that the step (H) of processing the said orders includes a step of generating the processing codes, from said converted orders, by a processing driver associated with said processing peripheral; and a step of sending said codes to said processing peripheral.

15. A method according to claim 14, characterised in that said data format, appropriate to the processing of said orders by the identified processing peripheral, is the EMF format.

16. A method according to any one of the preceding claims, characterised in that said communication network is a network of the Internet type.

17. A method according to any one of the preceding claims, characterised in that the client station and server station communicate using a communication protocol of the “hypertext transfer protocol” (HTTP) type.

18. A method according to claim 17, characterised in that said processing request message, said response message containing the translated orders and said page request are HTTP messages including a supplementary field (Xnext) containing the electronic address corresponding to a page to be processed of the document.

19. A method according to any one of the preceding claims, characterised in that said computer communication language is a language of the “hypertext markup language” type.

20. A method according to claim 19, characterised in that said communication language is the XML language.

21. A method according to any one of the preceding claims, characterised in that the electronic address at which the orders corresponding to a page of the electronic document are stored is an address of the URL type.

22. A method according to any one of the preceding claims, characterised in that the processing of a document consists of a printing of the document.

23. A device (200) for transmitting pages of an electronic document by a client station (10, 12,13) to a server station (11) connected by a communication network (1), with a view to processing the document (100) by means of a processing peripheral (14, 20-22), the device having means (201) for generating the orders corresponding to the pages of said electronic document to be processed, means (205) for storing said orders grouped together by page of the document, and means (203) for sending a document processing request message to the server station, the device being characterised in that it comprises:
means (213) for receiving a request message, referred to as a “page request”, sent by the server station, said page request including information identifying a page of the document;
means (211) for translating into a computer communication language the orders corresponding to the identified page in the page request;
means (213) for sending to the server station a response message containing the translated orders corresponding to the identified page.

24. A device according to claim 23, characterised in that it has association means (207, 209) for associating with each of the pages of the document an electronic address indicative of the storage location of the orders corresponding to the page in question.

25. A device according to claim 24, characterised in that the association means (207, 209) include:
an association table (207) containing, for each page of said document, an electronic address indicative of the storage location of the orders corresponding to the page in question; and
means (209) of updating the association table according to the document to be processed and the pages of said document already processed.

26. A device according to claim 24 or 25, characterised in that it has means adapted for implementing a method of transmitting the pages of an electronic document, in accordance with any one of claims 2 to 22.

27. A device (300) for processing an electronic document in a server station (11), connected via a communication network (1) to at least one client station (10, 12, 13), and responsible for the management of at least one electronic document processing peripheral (14, 20-22), the device being characterised in that it comprises:
means (301) for receiving a message coming from a client station, said message including information identifying a page to be processed of an electronic document;
means (301) for sending a request message, referred to as a “page request”, to the client station, said page request including said page identification information, and aimed at obtaining from the client station the processing orders corresponding to the page identified by the identification information;
means (301) for receiving a response message from the client station, said response message containing the orders corresponding to the identified page translated into a computer communication language.

28. A processing device according to claim 27, characterised in that it also has means (301) for first receiving a processing request message coming from the client station, said processing request message including information identifying a processing peripheral and information identifying a first page to be processed of the document; and in that said response message received from the client station also includes information identifying a following page to be processed of the document.

29. A processing device according to claim 28, characterised in that it also has:
means (306) for converting the orders received, from the computer communication language into a data format appropriate to the processing of said orders by the computer peripheral identified by said peripheral identification information;
processing means (311, 313) for the processing by the identified peripheral of said orders converted into said data format.

30. A processing device according to claim 27, characterised in that said processing means (311, 313) include:
means (313) for generating processing codes from said converted orders; and
means (311) for sending said codes to said processing peripheral.

31. A processing device according to any one of claims 28 to 30, characterised in that it has means adapted to implementing a processing method according to any one of claims 10 to 22.

32. A computer system including a device for transmitting the pages of an electronic document according to any one of claims 23 to 26, and/or a device for processing an electronic document according to any one of claims 27 to 31.

33. A client station connected to a communication network, characterised in that it has a device for transmitting the pages of an electronic document, according to any one of claims 23 to 26.

34. A server station connected to a communication network, characterised in that it has a device for processing an electronic document according to any one of claims 27 to 31.

35. A communication network including at least one client station according to claim 33, and at least one server station according to claim 34.
